(19) United States
(12) Patent Application Publication
(10) Pub. No.: US 2026/0147708 A1
(43) Pub. Date: May 28, 2026

(54) CONTROLLER, MEMORY DEVICE AND DATA STORAGE DEVICE

(71) Applicant: SK hynix Inc., Icheon-si (KR)

(72) Inventors: Dong Hun JEONG, Icheon-si (KR); Young Jo KIM, Icheon-si (KR); Ji Hun PARK, Icheon-si (KR); Bo Seok JEONG, Icheon-si (KR); Jae Won CHUNG, Icheon-si (KR)

(21) Appl. No.: 19/097,420

(22) Filed: Apr. 1, 2025

(30) Foreign Application Priority Data
Nov. 25, 2024 (KR) 10-2024-0169278

(51) Int. Cl. G06F 12/0802

(52) U.S. Cl. CPC G06F 12/0802

(57) ABSTRACT

A data storage device includes a volatile memory and a nonvolatile memory, and a caching function is provided by storing a cache line including compressed user data and tag data in the volatile memory. Therefore, increases in the number of accesses and addition of a storage region using the volatile memory for caching functions are prevented, resulting in a data storage device with improved caching operation performance.

### CROSS-REFERENCE TO RELATED APPLICATION

The present application claims priority under 35 U.S.C. § 119(a) to Korean Patent Application No. 10-2024-0169278 filed in the Korean Intellectual Property Office on Nov. 25, 2024, which is incorporated herein by reference in its entirety.

### BACKGROUND

### 1. Technical Field

Embodiments of the present disclosure relate to a controller, a memory device and a data storage device.

### 2. Related Art

A data storage device may include at least one memory that stores data. The data storage device may include a controller that controls at least one memory.

The type of at least one memory included in the data storage device may vary. For example, the at least one memory may be volatile memory or nonvolatile memory. Access speed to the memory or the storage capacity of the memory may vary.

As the case may be, a data storage device may include a plurality of memories of different types. Control may be required to efficiently operate the memories of different types.

### SUMMARY

The tasks of embodiments of the present disclosure are not limited to the tasks mentioned in this specification, and other tasks not mentioned will be clearly understood by those skilled in the art from the description below.

Embodiments of the present disclosure are directed to providing measures capable of improving the performance of a data storage device by efficiently operating a plurality of memories included in the data storage device, with the plurality of memories having different characteristics.

In an embodiment, a data storage device may include: a nonvolatile memory configured to store user data; a volatile memory including a first storage region and a second storage region, a cache line including a user data stored in the first storage region; and a controller configured to perform a compression operation on the user data, and, when the compression operation succeeds, store the cache line including compressed user data and a tag data including address information of the user data in the first storage region of the volatile memory.

In an embodiment, a memory device may include: a first storage region configured to store a plurality of cache lines; and a second storage region distinguished from the first storage region, wherein the plurality of cache lines include a first cache line and a second cache line, the first cache line includes compressed user data and first tag data, and the second cache line includes a part of a uncompressed user data and second tag data.

In an embodiment, a controller may include: a compression unit configured to compress or decompress user data; and a control logic configured to control a compression operation on the user data by the compression unit, and, when the compression operation succeeds, store a cache line including compressed user data and tag data that includes address information of the user data in a memory.

According to the embodiments of the present disclosure, when processing a request for a data storage device including a plurality of memories of different types, delay time according to processing of the request may be reduced, thereby improving the operational performance of the data storage device.

Effects of the embodiments of the present disclosure are not limited to those mentioned above, and other effects and benefits not mentioned will be clearly understood by those skilled in the art from the description of claims.

### BRIEF DESCRIPTION OF THE DRAWINGS

The present disclosure will be more fully understood from the detailed description to be made below and the accompanying drawings, which are provided for illustration only and are not intended to limit the present disclosure.

FIG. 1 is a diagram illustrating a schematic configuration of a data storage device according to embodiments of the present disclosure.

FIG. 2 is a diagram illustrating an example of a caching operation scheme of a data storage device according to embodiments of the present disclosure.

FIG. 3 is a diagram illustrating another example of a caching operation scheme of a data storage device according to embodiments of the present disclosure.

FIG. 4 is a diagram illustrating a scheme of generating a cache line in a data storage device according to embodiments of the present disclosure.

FIG. 5 is a diagram illustrating an example of tag data included in a cache line generated by a data storage device according to embodiments of the present disclosure.

FIG. 6 to FIG. 8 are diagrams illustrating examples of a data storage device processing a cache line according to a request from a host device according to embodiments of the present disclosure.

FIG. 9 is a diagram illustrating an example of an implementation of a data storage device according to embodiments of the present disclosure.

FIG. 10 is a diagram illustrating a method for operating a data storage device according to embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings. Further, in the following description of examples or embodiments of the present disclosure, detailed descriptions of well-known functions and components incorporated herein will be omitted when it is determined that the description may make the subject matter in some embodiments of the present disclosure more unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, or manufacturing methods, these terms may be used to describe non-consecutive or non-sequential processes or operations unless the term “directly” or “immediately” is used together.

In addition, when any dimensions, relative sizes etc. are mentioned, it should be considered that numerical values for elements or features, or corresponding information (e.g., level, range, etc.) include a tolerance range or error margin that may be caused by various factors (e.g., process factors, internal or external impact, noise, etc.) even when a relevant description is not specified. Further, the term “may” fully encompasses all the meanings of the term “can.”

Hereinafter, various embodiments of the present disclosure will be described in detail with reference to accompanying drawings.

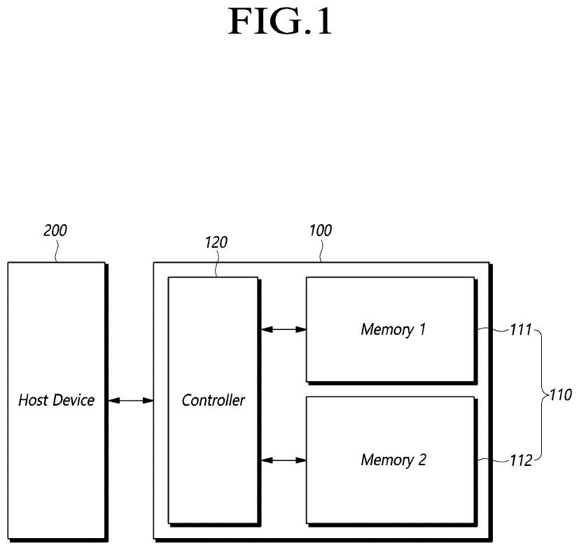

FIG. 1 is a diagram illustrating a schematic configuration of a data storage device 100 according to embodiments of the present disclosure.

Referring to FIG. 1, a data storage device 100 according to the embodiments of the present disclosure may include at least one memory 110. The data storage device 100 may include, for example, a first memory 111 and a second memory 112. The type of the first memory 111 may be the same as the type of the second memory 112. Alternatively, the type of the first memory 111 may be different from the type of the second memory 112.

For example, the first memory 111 may be volatile memory. The first memory 111 may be DRAM, SDRAM, DDR SDRAM, LPDDR SDRAM, etc., but examples are not limited thereto. The second memory 112 may be nonvolatile memory. The second memory 112 may be NAND flash memory, 3D NAND flash memory, NOR flash memory, etc., but examples are not limited thereto. The second memory 112 may be one of various types of memory such as resistive RAM, phase change memory, magnetoresistive memory, ferroelectric memory and spin transfer torque memory. The first memory 111 or the second memory 112 may be processing-in-memory which includes a logic for performing a computation function, or may be memory which performs a computation function using memory cells.

The access speed to the first memory 111 or the operating speed of the first memory 111 may be faster than the access speed to the second memory 112 or the operating speed of the second memory 112. The access speed to the first memory 111 may be faster than the access speed to the second memory 112. The storage capacity of the first memory 111 and the storage capacity of the second memory 112 may be different from each other, and the storage capacity of the second memory 112 may be larger than the storage capacity of the first memory 111.

A controller 120 may control the operations of the first memory 111 and the second memory 112. The controller 120 may control the operations of the first memory 111 and the second memory 112 on the basis of a command or a request received from a device outside the data storage device 100. Alternatively, the controller 120 may control the operations of the first memory 111 and the second memory 112 on the basis of an internal command of the data storage device 100.

The controller 120 may control the operations of the first memory 111 and the second memory 112 while communicating with a device located outside the data storage device 100. The data storage device 100 may be a device that operates while communicating with an external device on the basis of, for example, the CXL (Compute Express Link) standard. The controller 120 may control the operations of the first memory 111 and the second memory 112 while communicating with the external device according to the CXL standard. In other examples, the controller 120 may communicate with the external device using various interfaces such as PCIe.

In the controller 120, a section that processes a command received from the outside and a section which controls the operations of the first memory 111 and the second memory 112 may be configured as one chip or may be configured as separate chips. For example, respective sections may be implemented with chiplets, and a plurality of chiplets may be connected to configure the controller 120.

The data storage device 100 may operate according to a command received from the outside, and for example, may operate according to a command received from a host device 200. The controller 120 may transmit a data processing result, generated according to a command of the host device 200, to the host device 200.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, an RFID (radio frequency identification) device, a mobility device (e.g., a vehicle, a robot or a drone) capable of traveling under human control or autonomous driving, etc. Alternatively, the host device 200 may be a virtual/augmented reality device that provides a 2D or 3D virtual reality image or augmented reality image. The host device 200 may be any one of various electronic devices that require a data storage device 100 capable of storing data.

The host device 200 may include at least one operating system. The operating system may manage and control overall functions and operations of the host device 200. The operating system may also control the interoperation between the host device 200 and the data storage device 100. The operating system may be classified into a general operating system and a mobile operating system depending on the mobility of the host device 200.

The controller 120 included in the data storage device 100 may be a device that is separated from the host device 200. The controller 120 may be implemented by being integrated with the host device 200 into one device. Some components or functions of the controller 120 may be implemented by being included in the host device 200. In the following, for the sake of convenience in explanation, examples below describe a controller 120 and a host device 200 that are separated from each other, but embodiments of the present disclosure are not limited thereto.

When the types of the first memory 111 and the second memory 112 included in the data storage device 100 are different from each other, the controller 120 may process a request from the host device 200 while controlling the first memory 111 and the second memory 112 according to the characteristics of each of the first memory 111 and the second memory 112.

For example, when the first memory 111 is volatile memory with fast access speed and the second memory 112 is nonvolatile memory with a larger storage capacity, the controller 120 may provide a caching function using the first memory 111.

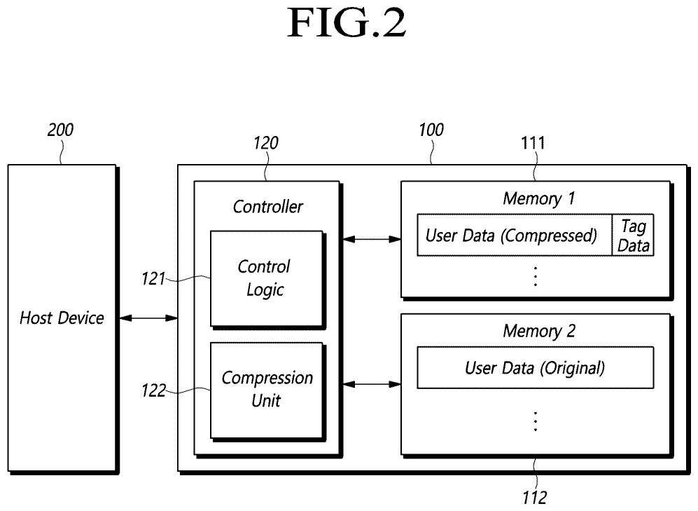

FIG. 2 is a diagram illustrating an example of a caching operation scheme of a data storage device 100 according to embodiments of the present disclosure.

Referring to FIG. 2, a data storage device 100 may include a first memory 111 and a second memory 112. The first memory 111 may be, for example, volatile memory such as DRAM. The second memory 112 may be, for example, nonvolatile memory such as NAND flash memory.

The controller 120 of the data storage device 100 may provide a caching function by storing user data, which is stored in the second memory 112, in the first memory 111. When storing the user data stored in the second memory 112 in the first memory 111, the controller 120 may compress at least a part of the user data and store compressed user data in the first memory 111.

The controller 120 may include, for example, a control logic 121 and a compression unit 122. The control logic 121 may control overall operations of the first memory 111 and the second memory 112. The control logic 121 may perform processing for a request from the host device 200.

The control logic 121 may control the caching function, and when performing the caching function, may control a compression operation by the compression unit 122.

The compression unit 122 may compress at least a part of user data stored in the second memory 112. The compression unit 122 may perform an operation of decompressing user data stored in the first memory 111.

The control logic 121 may compress original user data stored in the second memory 112 through the compression unit 122 and store compressed user data in the first memory 111. The control logic 121 may store a cache line including the compressed user data and tag data in the first memory 111.

The tag data may include address information of the user data. The tag data may further include information related with a cache line stored in the first memory 111. For example, the tag data may further include information indicating whether the cache line is valid, etc. in addition to the address information of the user data.

Since the cache line includes the compressed user data and the tag data, the control logic 121 may read the compressed user data and the tag data by accessing the first memory 111 once. The size of the cache line may be set to a size that may be read from the first memory 111 by the control logic 121 in a single access. For example, the size of the cache line may be 64B, but examples are not limited thereto.

Since the cache line includes the tag data, the size of the compressed user data may be set to be equal to or smaller than a size obtained by subtracting the size of the tag data from the size of the cache line. The tag data may be included in the cache line in an uncompressed state. The control logic 121 may determine the compression ratio of the user data on the basis of the ratio of the size of the cache line and the size of the tag data.

The size of the tag data may be, for example, 4B, but examples are not limited thereto. Since the size of the tag data does not account for a large proportion in the size of the cache line, the compression ratio of the user data may not be large. Since the user data is compressed at a low compression ratio, the possibility of an error occurring when compressing the user data may be low.

Since the controller 120 provides a caching function while compressing the user data and storing the cache line, including the compressed user data and the tag data, in the first memory 111, a separate storage space for storing the tag data may not be required. Since the compressed user data and the tag data are simultaneously read, a separate read operation for reading the tag data may not be required. The performance of a caching operation using the first memory 111 included in the data storage device 100 may be improved.

Since the data storage device 100 compresses user data with a low compression ratio, the data storage device 100 may provide a caching function while reducing the possibility of failure in a compression operation. However, the data storage device 100 may be implemented to provide a caching function when a compression operation on user data fails.

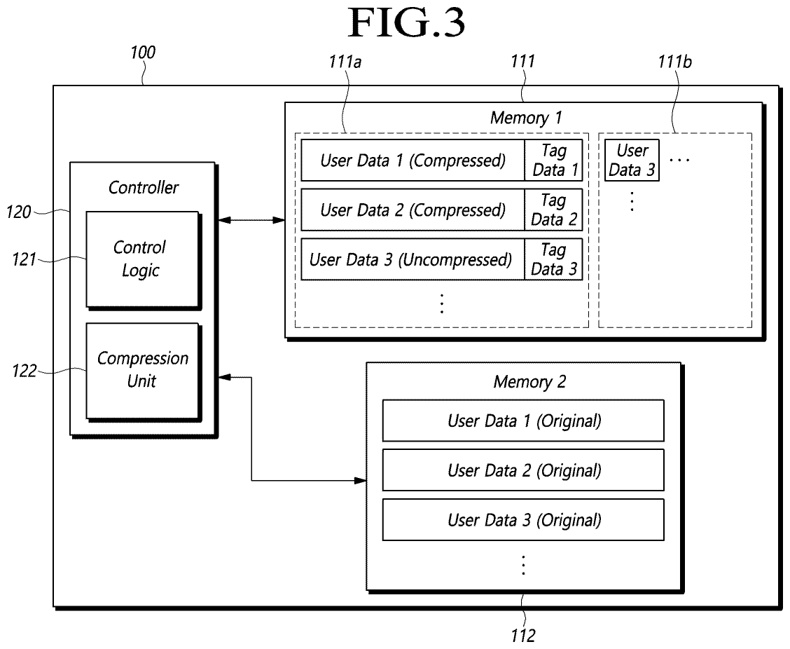

FIG. 3 is a diagram illustrating another example of a caching operation scheme of a data storage device according to embodiments of the present disclosure.

Referring to FIG. 3, a data storage device 100 may include a first memory 111 and a second memory 112. A controller 120 of a data storage device 100 may include a control logic 121 and a compression unit 122, and may compress at least a part of user data stored in the second memory 112 and store a cache line in the first memory 111. The cache line may include compressed user data and tag data. The tag data may include address information of the user data.

A cache line may include uncompressed user data and tag data. When compression fails during a compression operation by the controller 120, the controller 120 may store a cache line including a part of uncompressed user data and tag data in the first memory 111. The controller 120 may store the remainder of the uncompressed user data in the first memory 111. A region where the cache line is stored and a region where the remainder of the uncompressed user data is stored may be distinguished from each other.

For example, the first memory 111 may include a first storage region 111a and a second storage region 111b.

At least one cache line may be stored in the first storage region 111a. Each cache line may include compressed user data and tag data. In some cases, some cache line may include a part of uncompressed user data and tag data. For example, all cache line stored in the first storage region 111a may include compressed user data and tag data. Alternatively, all cache line stored in the first storage region 111a may include a part of uncompressed user data and tag data. Alternatively, some cache line stored in the first storage region 111a may include compressed user data and tag data and rest cache line stored in the first storage region 111a may include a part of uncompressed user data and tag data.

For example, a cache line including compressed first user data and first tag data may be stored in the first storage region 111a of the first memory 111. A cache line including compressed second user data and second tag data may be stored in the first storage region 111a. The first tag data and the second tag data may be uncompressed data.

As compression operations on first user data and second user data stored in the second memory 112 are successfully executed, the controller 120 may store the cache lines including the compressed first and second user data in the first storage region 111a as in the examples described above.

A cache line including a part of uncompressed third user data and third tag data may be stored in the first storage region 111a. A compression operation may fail when the controller 120 performs a compression operation on third user data stored in the second memory 112. When the compression operation fails, the controller 120 may configure the cache line including the part of the uncompressed third user data and the third tag data. The third tag data may be uncompressed data.

The controller 120 may store the remainder of the uncompressed third user data in the second storage region 111b of the first memory 111. A first part of the uncompressed third user data may be stored in the first storage region 111a, and a second part of the uncompressed third user data may be stored in the second storage region 111b.

The size of the second part of the uncompressed third user data may be the same as, for example, the size of the third tag data. The controller 120 may store the remainder of user data in the second storage region 111b when compression of the user data fails, and the controller 120 also may store a cache line composed of a part of the uncompressed user data and tag data in the first storage region 111a. Thus, all of the cache lines stored in the first storage region 111a may include compressed user data and tag data, but sometimes some of the cache lines may include a part of uncompressed user data and tag data.

Since a cache line is configured to include compressed user data and tag data, the controller 120 may read the cache line by accessing the first memory 111 once.

In embodiments of the disclosure, because the first memory 111 is accessed to read the remainder of uncompressed user data in the second storage region 111b only when compression of user data fails, the number of read times may be reduced compared to when tag data is separately stored. For example, when the cache line includes compressed user data and tag data, user data may be read by accessing the first storage region 111a only. And when the cache line includes a part of uncompressed user data and tag data, user data may be read by accessing both of the first storage region 111a and the second storage region 111b. Comparing to a case that all tag data is stored in the second storage region 111b, a number of accessing to the second storage region 111b for reading user data may be reduced.

In addition, since a region where the remainder of uncompressed user data is to be stored is needed only when compression of user data fails, a storage region equal to or larger than the size of a storage region that is required when separately storing tag data may not be required. For example, the size of the second storage region 111b may be equal to or smaller than the total sum of sizes of tag data that can be stored in the first storage region 111a. The size of the second storage region 111b may be set to a size corresponding to the product of the number of cache lines which can be stored in the first storage region 111a and the size of tag data. The size of the second storage region 111b may also be set to a size smaller than the corresponding size in consideration of the failure rate of compression operations.

Therefore, in data storage devices according to embodiments of the present disclosure, an additional storage region is not required in the first memory 111 to store a cache line and perform a caching function. When a cache line is composed of compressed user data and tag data, the number of accesses to the first memory 111 may decrease, so the operational performance of the caching function may be improved.

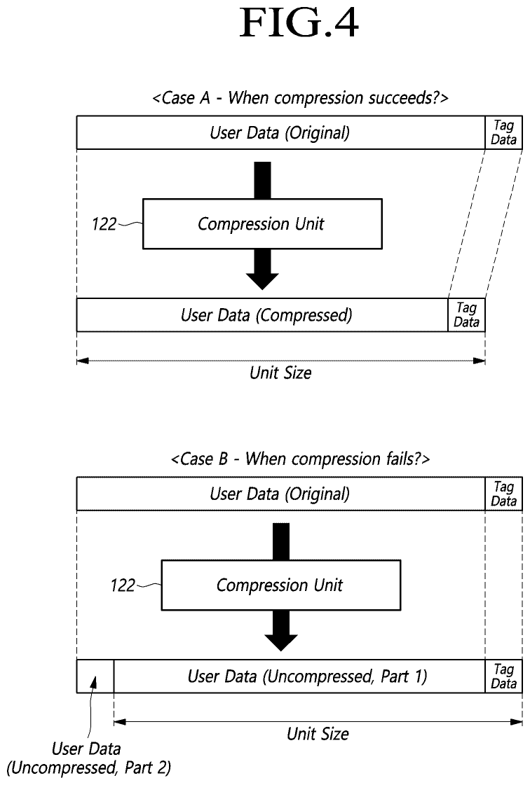

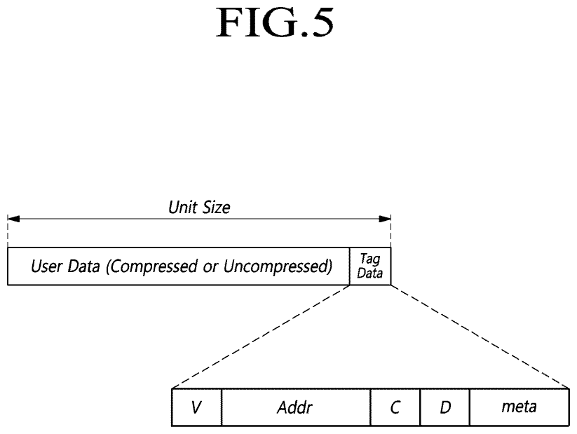

FIG. 4 is a diagram illustrating a scheme of generating a cache line in a data storage device according to the embodiments of the present disclosure. FIG. 5 is a diagram illustrating an example of tag data included in a cache line generated by a data storage device according to embodiments of the present disclosure.

FIG. 4 illustrates examples of cache lines in successful and unsuccessful compression operations executed by a compression unit 122 of a controller 120.

For example, <Case A> illustrates an example of a cache line in a case where compression of user data succeeds.

When a compression operation by the compression unit 122 succeeds, a cache line including compressed user data and tag data may be provided. The user data may be compressed and the tag data may be uncompressed. The size of the cache line including the compressed user data and the uncompressed tag data may be a unit size. The unit size may be, for example, the size of data that is read when the controller 120 accesses a first memory 111.

The compression ratio of the compressed user data may be determined on the basis of the size of the cache line and the size of the tag data. Since the size of the tag data does not account for a large proportion in the size of the cache line, the compression ratio of the user data may be low. As a result, failure rate when performing a compression operation on user data may be lowered.

A cache line may be configured to provide a caching function even when a compression operation on user data fails.

For example, <Case B> illustrates an example of a cache line in a case where compression of user data fails.

When a compression operation by the compression unit 122 fails, a control logic 121 may configure a cache line to include a first part of uncompressed user data and tag data. The tag data may be in an uncompressed state. The size of the cache line may be a unit size.

The control logic 121 may store a second part of the uncompressed user data in a region of the volatile memory that is distinguished from a region where the cache line is stored. The size of the second part of the uncompressed user data may be the same as the size of the tag data.

The efficiency of a caching function may be improved by storing a cache line by performing a compression operation on user data. An additional storage region for storing a cache line and performing a caching function is not required when the remainder of uncompressed user data is stored and read in a separate region only when a compression operation on user data fails.

Because a scheme in which user data is stored in the first memory 111 differs depending on whether the user data is compressed, tag data may include information indicating whether the user data is compressed.

For example, referring to FIG. 5, tag data may include a valid field V indicating whether a cache line is valid, address information Addr of user data included in the cache line, information C indicating whether the user data is compressed, dirty information D indicating whether the user data is updated, and other meta information meta.

The address information of the user data may be information indicating an address where the user data is stored in a second memory 112, which can be used for comparing user data included in the cache line and user data stored in a non-volatile second memory 112.

The information indicating whether the user data is compressed may indicate whether the user data included in the cache line is compressed. When the corresponding information indicates a compressed state, the user data may be provided by reading the cache line. When the corresponding information indicates an uncompressed state, the user data may be provided by reading the remainder of uncompressed user data in addition to the cache line.

Although information included in tag data is not limited to the examples described above, address information and information indicating whether compression is performed is included in the tag data to support a caching function when user data is compressed.

When a request is generated by an external device such as a host device 200, the controller 120 may check a cache line stored in the first memory 111 and provide a response to the request of the host device 200.

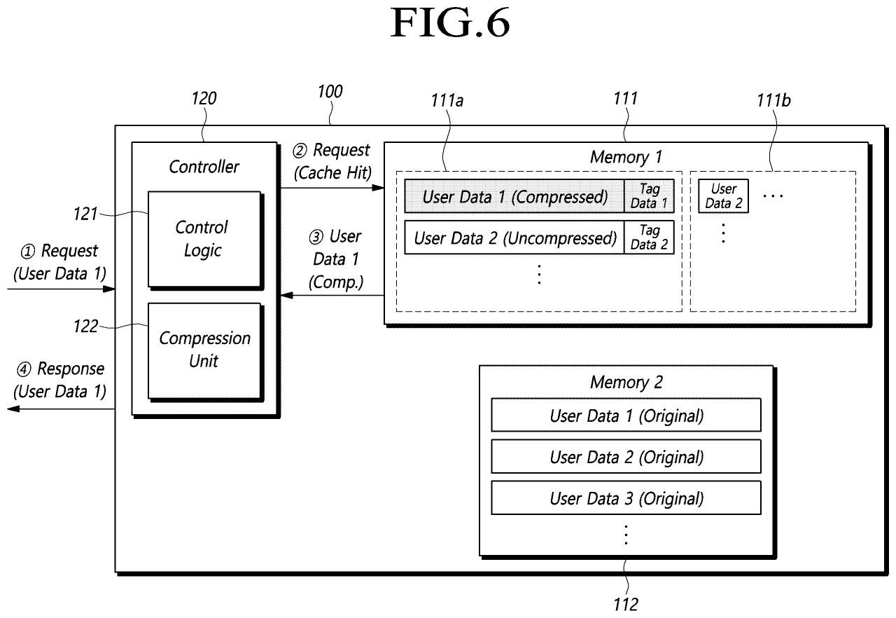

FIG. 6 to FIG. 8 are diagrams illustrating examples of a data storage device processing a cache line according to a request from a host device according to embodiments of the present disclosure.

FIG. 6 illustrates an example in which first user data, second user data, third user data, and so on are stored in a second memory 112 included in a data storage device 100.

A controller 120 of the data storage device 100 may cache at least a part of user data stored in the second memory 112 and store the part in a first memory 111.

The controller 120 may compress the user data stored in the second memory 112 and store compressed user data in the first memory 111. When compression of the user data stored in the second memory 112 fails, the controller 120 may separately store a part of the uncompressed user data and the remainder of the uncompressed user data in the first memory 111.

For example, the controller 120 may compress the first user data (User Data 1) stored in the second memory 112 and store compressed first user data in the first memory 111. The controller 120 may store a cache line including the compressed first user data and first tag data in a first storage region 111a of the first memory 111.

The controller 120 may perform a compression operation on the second user data (User Data 2) stored in the second memory 112. The compression operation performed on the second user data by the controller 120 may fail. In this case, the controller 120 may store a cache line including a part of the second user data, which is uncompressed, and second tag data in the first storage region 111a of the first memory 111. The controller 120 may store the remainder of the uncompressed second user data in a second storage region 111b of the first memory 111.

The size of the cache line including the compressed first user data and the first tag data may be the same as the size of the cache line including part of the uncompressed second user data and the second tag data. The size of the remainder of the uncompressed second user data stored in the second storage region 111b of the first memory 111 may be the same as the size of the second tag data.

The data storage device 100 may provide a response to a request from a host device 200 (not illustrated) using a cache line including compressed user data and a cache line including uncompressed user data, both cached in the first memory 111.

For example, a request for first user data may be generated by host device 200 (\textcircled{1}).

When receiving the request for the first user data, the controller 120 of the data storage device 100 may check the first memory 111. When the controller 120 checks that the first user data is stored in the first memory 111, that is, when a cache hit occurs (\textcircled{2}), the controller 120 may read the cache line including the first user data from the first storage region 111a of the first memory 111 (\textcircled{3}).

The controller 120 may check the first tag data included in the cache line read from the first storage region 111a. The controller 120 may check, through the first tag data, whether the first user data included in the cache line is compressed. When the first user data in the cache line is determined to be in a compressed state, the controller 120 may perform a decompression operation on the first user data.

The controller 120 may provide decompressed first user data to the host device 200 (\textcircled{4}).

In this way, the controller 120 may decompress the cache line cached in the first storage region 111a of the first memory 111 upon occurrence of the cache hit according to a request from a host device 200, and may provide the uncompressed first user data to the host device 200.

When user data included in a cache line is not compressed, the controller 120 may process a request from the host device 200 while performing an additional read operation.

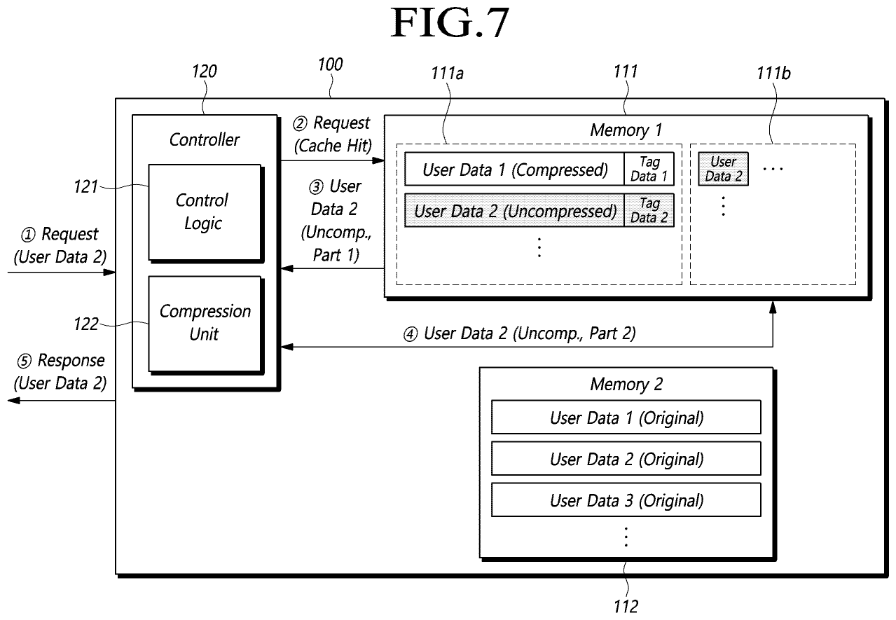

For example, referring to FIG. 7, the data storage device 100 may receive a request for the second user data (User Data 2) from the host device 200 (\textcircled{1}).

In response to the request of the host device 200, the controller 120 of the data storage device 100 may check whether the second user data is cached in the first memory 111. When a cache hit for the second user data occurs (\textcircled{2}), the controller 120 may read the cache line including the second user data from the first memory 111 (\textcircled{3}).

The controller 120 may check the second tag data included in the cache line. The controller 120 may determine, using the second tag data, that the second user data included in the cache line is in an uncompressed state.

When the second user data included in the cache line is in an uncompressed state, the controller 120 may read the remainder of the uncompressed second user data from the second storage region 111b of the first memory 111 (\textcircled{4}). The controller 120 may obtain a first part of the uncompressed second user data from the cache line in the first storage region 111a of the first memory 111, and may obtain a second part of the uncompressed second user data from the second storage region 111b of the first memory 111.

The controller 120 may provide both the first part of the second user data obtained from the first storage region 111a and the second part of the second user data obtained from the second storage

region 111b to the host device 200 (\textcircled{5}).

When user data according to a request from the host device 200 is not stored in the first memory 111, the controller 120 may read the corresponding user data by accessing the second memory 112. In this process, the controller 120 may perform an operation of moving at least a part of user data cached in the first memory 111 to the second memory 112.

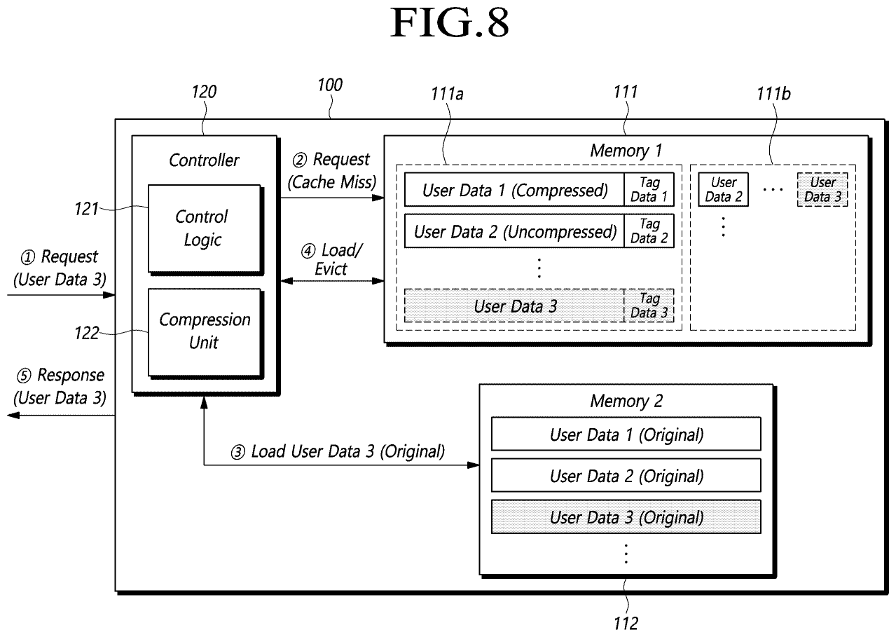

For example, referring to FIG. 8, the data storage device 100 may receive a request for third user data (User Data 3) from the host device 200 (\textcircled{1}).

The controller 120 of the data storage device 100 may check whether the third user data is stored in the first memory 111. The controller 120 may determine that the third user data is not stored in the first memory 111 (\textcircled{2}). A cache miss may occur.

When a cache miss occurs, the controller 120 may read third user data while accessing the second memory 112 (\textcircled{3}). The controller 120 may load the third user data into the first memory 111 (\textcircled{4}). The controller 120 may perform an operation of evicting or moving at least a part of user data stored in the first memory 111 to the second memory 112.

While loading the third user data into the first memory 111, the controller 120 may perform a compression operation on the third user data. When the compression operation succeeds, the controller 120 may store a cache line including compressed third user data and third tag data in the first storage region 111a of the first memory 111. If the compression operation fails, then the controller 120 may store a cache line including a part of uncompressed third user data and third tag data in the first storage region 111a of the first memory 111, and store the remainder of the uncompressed third user data in the second storage region 111b of the first memory 111.

When evicting user data loaded into the first memory 111, the controller 120 may check the tag data of the cache line for the data targeted for eviction. Using the tag data, the controller 120 may determine whether the user data included in the corresponding cache line is compressed.

When the user data is compressed, the controller 120 may decompress the user data and then store the user data in the second memory 112. When the user data is not compressed, the controller 120 may read the remainder of the user data from the second storage region 111b of the first memory 111, combine the remainder of the user data with the corresponding user data in the cache line read from the first storage region 111a, and then may store the user data in the second memory 112.

The controller 120 may provide the third user data read from the second memory 112 to the host device 200 (\textcircled{5}).

In disclosed embodiments, a cache line is configured by compressing user data stored in the second memory 112 and stored in the first memory 111 in a unit of constant size. Thus, a caching function may be provided while maintaining stored cache lines of a constant unit size in the first memory 111. Since compression is performed with a compression ratio according to the ratio of the size of tag data to the size of a cache line, failures in compression operations may decrease. When a compression operation fails, the remainder of uncompressed user data is cached in a region of the first memory 111 distinguished from a region where a cache line is stored, so a caching operation may be performed regardless of whether a compression operation succeeds or fails.

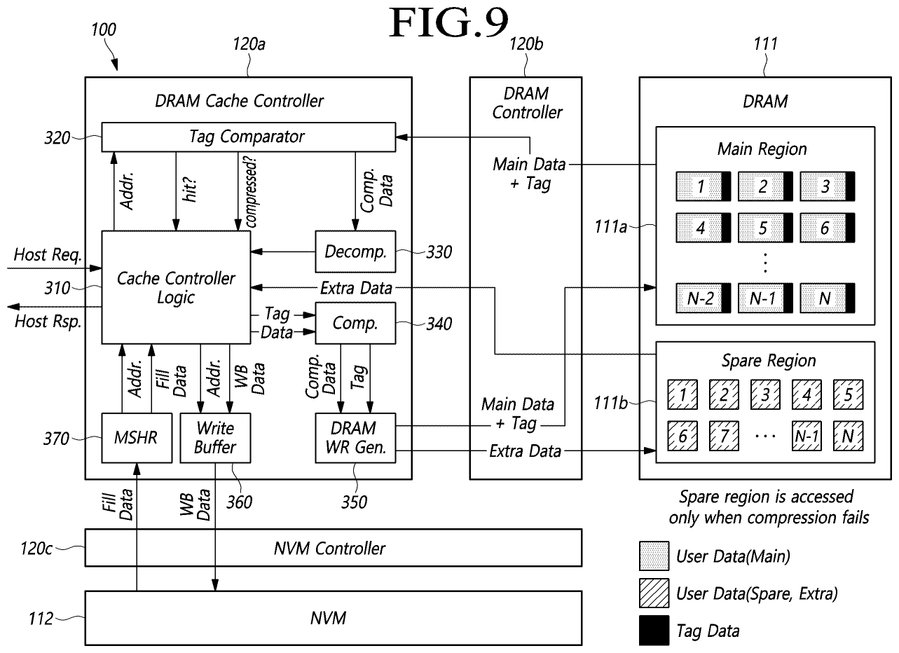

FIG. 9 is a diagram illustrating an example of an implementation of a data storage device according to embodiments of the present disclosure.

Referring to FIG. 9, as an example, a first memory 111 included in a data storage device 100 is DRAM and a second memory 112 is nonvolatile memory. The data storage device 100 may include a DRAM cache controller 120a, a DRAM controller 120b and an NVM controller 120c.

The DRAM cache controller 120a, the DRAM controller 120b and the NVM controller 120c may be included in different configurations, such as the following non-limiting examples. The DRAM cache controller 120a, the DRAM controller 120b and the NVM controller 120c may be implemented as one chip and be provided as the controller 120. The DRAM cache controller 120a, the DRAM controller 120b and the NVM controller 120c may be implemented with chiplets, respectively, and may be connected to each other to be provided as the controller 120. The DRAM cache controller 120a only may be included in the controller 120, the DRAM controller 120b may be included in the first memory 111, and the NVM controller 120c may be included in the second memory 112.

The DRAM cache controller 120a may include, for example, a cache controller logic 310, a tag comparator 320, a decompression section 330, a compression section 340, a DRAM write generator 350, a write buffer 360, and a miss buffer 370.

The cache controller logic 310, the tag comparator 320, the DRAM write generator 350, the write buffer 360 and the miss buffer 370 may be regarded as components that are included in a control logic 121 of the controller 120. The decompression section 330 and the compression section 340 may be regarded as components that are included in a compression unit 122 of the controller 120.

The cache controller logic 310 may control the overall operations of a caching function performed by the data storage device 100. The tag comparator 320 may check the information of tag data of a cache line read from the first memory 111 according to a command from the cache controller logic 310. The decompression section 330 and the compression section 340 may control compression and decompression operations for a cache line. The DRAM write generator 350 may generate data or a cache line to be stored in the first memory 111.

When the cache controller logic 310 receives a request from a host device 200, the cache controller logic 310 may transmit address information to the tag comparator 320. When a cache hit occurs, a cache line may be read to the tag comparator 320 from the first storage region 111a of the first memory 111. The first storage region 111a may be referred to as a main region. User data included in the cache line may be referred to as main data.

The tag comparator 320 may check tag data of the read cache line. When the tag data indicates that the user data is in a compressed state, a decompression operation may be performed by the decompression section 330. Decompressed user data may be provided to the host device 200 through the cache controller logic 310.

When the tag data indicates that the user data is in an uncompressed state, the cache controller logic 310 may read the remainder of the user data from the second storage region 111b of the first memory 111, which is also uncompressed. The second storage region 111b may be referred to as a spare region. The remainder of the user data stored in the second storage region 111b may be referred to as extra data. The cache controller logic 310 may combine the main data read from the first storage region 111a and the extra data read from the second storage region 111b, and may provide the user data to the host device 200.

When a cache miss occurs, the cache controller logic 310 may access the second memory 112 and load user data requested by the host device 200. The cache controller logic 310 may load the user data associated with the cache miss using the miss buffer 370 and provide the user data to the host device 200.

When loading the user data associated with the cache miss, the cache controller logic 310 may evict user data and move user data stored in the first memory 111 to the second memory 112. The cache controller logic 310 may perform an operation of storing the user data in the second memory 112 using the write buffer 360.

When performing a caching operation or performing an update of user data according to a request from the host device 200, the cache controller logic 310 may perform a compression operation through the compression section 340. When a compression operation on user data succeeds, the cache controller logic 310 may store a cache line including compressed user data and tag data in the first memory 111 using the DRAM write generator 350.

When a compression operation on user data fails, the cache controller logic 310 may store a cache line including a part of uncompressed user data and tag data in the first storage region 111a of the first memory 111 through the DRAM write generator 350. The remainder of the uncompressed user data may be stored in the second storage region 111b of the first memory 111.

The second storage region 111b may be accessed only when compression of user data included in a cache line fails. The amount of time required for a compression operation on user data may be shorter than a time required according to access to the second storage region 111b. By implementing cache lines for user data that are compressed and stored in the first memory 111 together with tag data, the number of times the first memory 111 is accessed may decrease and the performance of caching operations may be improved.

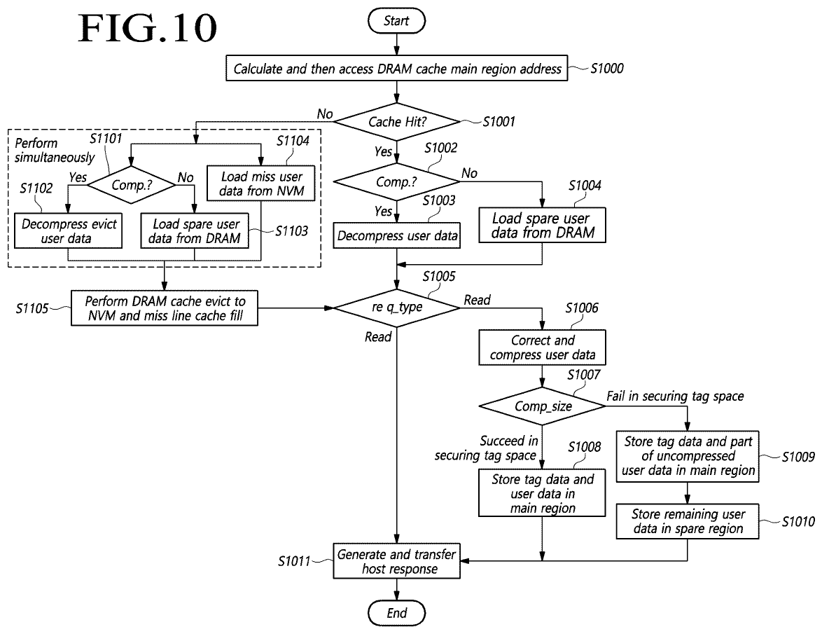

FIG. 10 is a diagram illustrating a method for operating a data storage device according to embodiments of the present disclosure.

Referring to FIG. 10, a data storage device 100 may calculate an address of a main region of the first memory 111 and then access user data cached in the first memory 111 (S1000).

When a cache hit occurs, the data storage device 100 may read a cache line from the first memory 111 (S1001). The data storage device 100 may check, using tag data included in the cache line, whether the user data included in the cache line is compressed (S1002).

When the user data included in the cache line is in a compressed state, the data storage device 100 may perform a decompression operation on the user data (S1003). When the user data included in the cache line is in an uncompressed state, the data storage device 100 may read the remainder of the user data from the second storage region 111b of the first memory 111 (S1004).

The data storage device 100 may check the type of request received from the host device 200 (S1005). According to the type of the request, the data storage device 100 may provide the read user data to the host device 200 immediately (S1011) or correct the read data. For example, the type of the request may be a type requesting to read user data already stored. Alternatively, the type of request may be a type requesting to overwrite user data already stored.

When the type of request is a type requesting to overwrite user data, the data storage device 100 may correct the read user data and compress again corrected user data (S1006).

When the compression operation succeeds and thus a space for tag data is secured, the data storage device 100 may store a cache line including compressed user data and tag data in the first storage region 111a of the first memory 111 (S1008).

When the compression operation fails and thus a space for tag data is not secured (S1007), the data storage device 100 may store a cache line including a part of uncompressed user data and tag data in the first storage region 111a of the first memory 111 (S1009). The data storage device 100 may store the remainder of the uncompressed user data in the second storage region 111b of the first memory 111 (S1010).

When correction and storage of the user data are completed, the data storage device 100 may transmit a response to the host device 200 (S1011).

When a cache miss occurs, the data storage device 100 may read cache-missed user data from the second memory 112 (S1104).

The data storage device 100 may simultaneously perform an operation of evicting at least a part of cache lines stored in the first memory 111 to the second memory 112.

The data storage device 100 may read, for example, a cache line with a lowest usage frequency or an oldest caching time point. The data storage device 100 may check, through tag data included in the read cache line, whether user data included in the cache line is compressed (S1101).

When the user data of the cache line is compressed, the data storage device 100 may perform a decompression operation (S1102). When the user data of the cache line is not compressed, the data storage device 100 may read the remainder of the user data from the second storage region 111b of the first memory 111 (S1103) and evict uncompressed user data from the cache line and the second storage region 111b.

The data storage device 100 may perform an operation of evicting the cache line to the second memory 112 and an operation of loading the cache-missed user data to the first memory 111 (S1105).

According to the embodiments of the present disclosure, in a data storage device including volatile memory and nonvolatile memory, a caching function may be provided using the volatile memory. Since user data to be cached in the volatile memory is compressed and a cache line including compressed user data and tag data is stored in the volatile memory, an increase in the number of accesses due to storage of tag data may be reduced or prevented, and an additional storage region may not be required.

In addition, when compression of user data fails, since a cache line is configured with a part of uncompressed user data and tag data and the remainder of the uncompressed user data is stored in a storage region which is distinguished from a storage region where the cache line is stored, a caching function may be provided even when a compression operation fails. The performance of a caching operation by the data storage device including volatile memory and nonvolatile memory may be improved because the number of memory accesses does not increase or addition of a storage region for caching functions is not required.

Although various embodiments of the present disclosure have been described with particular specifics and varying details for illustrative purposes, those skilled in the art will appreciate that various modifications, additions and substitutions may be made based on what is disclosed or illustrated in the present disclosure without departing from the spirit and scope of the present disclosure as defined in the following claims.

What is claimed is:

1. A data storage device comprising:
a nonvolatile memory configured to store user data;
a volatile memory including a first storage region and a second storage region, a cache line including the user data stored in the first storage region; and
a controller configured to perform a compression operation on the user data, and, when the compression operation succeeds, store the cache line including compressed user data and a tag data including address information of the user data in the first storage region of the volatile memory.

2. The data storage device according to claim 1, wherein when the compression operation fails, the controller stores the cache line including a first part of the user data and the tag data in the first storage region of the volatile memory.

3. The data storage device according to claim 2, wherein the controller stores a second part of the user data excluding the first part of the user data in the second storage region of the volatile memory.

4. The data storage device according to claim 3, wherein a size of the second part of the user data is the same as a size of the tag data.

5. The data storage device according to claim 3, wherein the first part and the second part of the user data are uncompressed.

6. The data storage device according to claim 1, wherein the tag data includes information indicating whether the user data is compressed.

7. The data storage device according to claim 1, wherein a size of the second storage region is equal to or smaller than total size of the tag data that can be stored in the first storage region.

8. The data storage device according to claim 1, wherein a compression ratio of the user data is a ratio of a size of the cache line to a size of the tag data.

9. The data storage device according to claim 1, wherein the controller reads the cache line stored in the first storage region of the volatile memory, checks the tag data included in the cache line, and determines whether to access the second storage region using the tag data.

10. The data storage device according to claim 9, wherein when the tag data indicates that the user data is uncompressed, the controller accesses the second storage region of the volatile memory.

11. The data storage device according to claim 9, wherein a time required for the controller to access the second storage region of the volatile memory and read data from the second storage region is longer than a time required to perform the compression operation on the user data.

12. The data storage device according to claim 1, wherein the controller receives a request for a cache line, and when the cache line according to the request does not exist in the volatile memory, reads user data corresponding to the cache line from the nonvolatile memory.

13. The data storage device according to claim 12, wherein the controller reads a cache line to be evicted from the first storage region of the volatile memory, checks tag data included in the cache line, and, when user data included in the cache line is in a compressed state, performs a decompression operation on the user data and stores decompressed user data in the nonvolatile memory.

14. The data storage device according to claim 13, wherein when the user data included in the cache line is in an uncompressed state, the controller reads a corresponding remainder of the user data from the second storage region of the volatile memory and stores the user data in the nonvolatile memory.

15. A memory device comprising:
a first storage region configured to store a plurality of cache lines; and
a second storage region distinguished from the first storage region,
wherein the plurality of cache lines include a first cache line and a second cache line, the first cache line includes compressed user data and first tag data, and the second cache line includes a part of a uncompressed user data and second tag data.

16. The memory device according to claim 15, wherein the remainder of the uncompressed user data is stored in the second storage region.

17. The memory device according to claim 15, wherein a size of the remainder of the uncompressed user data is the same as a size of the tag data.

18. The memory device according to claim 15, wherein the tag data is uncompressed.

19. A controller comprising:
a compression unit configured to compress or decompress user data; and
a control logic configured to control a compression operation on the user data by the compression unit, and, when the compression operation succeeds, store a cache line including compressed user data and tag data that includes address information of the user data in a memory.

20. The controller according to claim 19, wherein when the compression operation fails, the control logic stores the cache line including a first part of the user data and the tag data in the memory, and stores a second part of the user data excluding the first part in another storage region of the same memory.
